(19) United States
(12) Patent Application Publication
(10) Pub. No.: US 2025/0061636 A1
(43) Pub. Date: Feb. 20, 2025

(54) CONTROLLING AN AVATAR OF A FIRST PARTICIPANT BY A SECOND PARTICIPANT

(71) Applicant: International Business Machines Corporation, Armonk, NY (US)

(72) Inventors: Jeremy R. Fox, Georgetown, TX (US); Atul Mene, Morrisville, NC (US); Tushar Agrawal, West Fargo, ND (US); Sarbajit K. Rakshit, Kolkata (IN)

(21) Appl. No.: 18/235,542

(22) Filed: Aug. 18, 2023

(51) Int. Cl. G06T 13/40; G06F 3/01; G06T 19/00

(52) U.S. Cl. CPC G06T 13/40; G06F 3/011; G06F 3/016; G06T 19/006

(57) ABSTRACT

A computer-implemented method, system, and computer program product for controlling an avatar of a first participant by a second participant. A selection of an activity or a step of an activity to be performed by the avatar of the first participant in a virtual environment that the first participant needs assistance in completing is received. Furthermore, a selection of the particular limbs (e.g., right arm) of the avatar of the first participant or a selection of the entire avatar of the first participant to be controlled by the second participant in order to complete the activity or the step of the activity is received. Control of the one or more limbs or the entire avatar of the first participant is then granted to the second participant.

### TECHNICAL FIELD

The present disclosure relates generally to collaborative virtual environments, and more particularly to controlling an avatar of a first participant by a second participant, such as to complete an activity or a step of an activity performed by the avatar of the first participant in a virtual environment.

### BACKGROUND

A collaborative virtual environment refers to the digital or virtual reality environment that consists of avatars and shared digital content. That is, a collaborative virtual environment is a space in which several people interact with each other, such as via avatars, often over several locations, in virtual reality.

### SUMMARY

In one embodiment of the present disclosure, a computer-implemented method for controlling an avatar of a first participant by a second participant comprises receiving a selection of an activity or a step of the activity to be performed by the avatar of the first participant in a virtual environment that the first participant needs assistance in completing. The method further comprises receiving a selection of one or more limbs of the avatar of the first participant or a selection of an entirety of the avatar of the first participant to be controlled by the second participant to complete the activity or the step of the activity. The method additionally comprises granting control of the one or more limbs or the entirety of the avatar of the first participant to the second participant.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components used by the avatar controller mechanism for enabling the second participant to control the movement of the limbs or the entire avatar of the first participant to complete an activity or a step of an activity in situations in which the first participant is unable to complete such activity or step of the activity through his/her avatar in accordance with an embodiment of the present disclosure;

FIG. 3 illustrates generating movements in the avatar of the first participant based on the movements of the second participant in accordance with an embodiment of the present disclosure;

FIG. 4 illustrates an embodiment of the hardware configuration of the avatar controller mechanism which is representative of a hardware environment for practicing the present disclosure; and

FIGS. 5A-5B are a flowchart of a method for enabling the second participant to control the movement of the limbs or the entire avatar of the first participant to complete an activity or a step of an activity in situations in which the first participant is unable to complete such activity or step of the activity through his/her avatar in accordance with an embodiment of the present disclosure.

### DETAILED DESCRIPTION

As stated above, a collaborative virtual environment refers to the digital or virtual reality environment that consists of avatars and shared digital content. That is, a collaborative virtual environment is a space in which several people interact with each other, such as via avatars, often over several locations, in virtual reality.

Virtual reality (VR) is a simulated experience that employs pose tracking and three-dimensional (3D) near-eye displays to give the user an immersive feel of a virtual world. Applications of virtual reality include entertainment (particularly video games), education (such as medical or military training) and business (such as virtual meetings). Other distinct types of VR-style technology include augmented reality and mixed reality, sometimes referred to as extended reality or XR.

Currently, standard virtual reality systems use either virtual reality headsets or multi-projected environments to generate some realistic images, sounds, and other sensations that simulate a user's physical presence in a virtual environment. A person using virtual reality equipment is able to look around the artificial world, move around in it, and interact with virtual features or items. The effect is commonly created by VR headsets consisting of a head-mounted display with a small screen in front of the eyes but can also be created through specially designed rooms with multiple large screens. Virtual reality typically incorporates auditory and video feedback but may also allow other types of sensory and force feedback through haptic technology.

Examples of utilizing virtual reality in such collaborative virtual environments include virtual meeting rooms where avatars of employees can connect to discuss challenges, work on projects, and tackle complex tasks as well as virtual building environments, where employees can design new products and experiment with designs in a three-dimensional environment. Other examples include training spaces designed to replicate real-life environments that would be dangerous or difficult for team members to access in reality, sales environments where employees can introduce customers to the features and capabilities of products for better onboarding and value demonstrations, and social spaces where remote workers can come together to learn new things, share information, and strengthen bonds.

In such collaborative virtual environments, each user will be represented by an avatar, which is a graphical representation of the user or the user's character or persona. Based on the actions of the user, the avatar may perform corresponding actions (e.g., movements) in the collaborative virtual environment. At times though, the user, and by extension the user's avatar, may not be able to perform such actions, such as an activity (e.g., planting virtual carrots in a virtual garden) or a step of an activity (e.g., moving across a room to pick-up an item, such as a virtual watering can, to water the virtual garden).

As a result, by the avatar not being able to complete the activity or step of an activity in the collaborative virtual environment, the digital collaboration among users becomes limited. For example, an avatar of a user may be waiting for such an activity or step of an activity to be completed prior to performing a further action in the collaborative virtual environment.

The embodiments of the present disclosure provide a means for controlling an avatar of a first participant by a second participant in the collaborative virtual environment. In particular, the principles of the present disclosure enable the second participant to control the movement of the limbs (e.g., hands, feet) or the entirety of the avatar of the first participant to complete an activity or a step of an activity in situations in which the first participant is unable to complete such activity or step of the activity through his/her avatar. In one embodiment, a selection of an activity or a step of an activity to be performed by the avatar of the first participant in the virtual environment (e.g., collaborative virtual environment) that is controlled by a designated second participant is received. Furthermore, an indication as to which limb (e.g., hand, foot, etc.) of the avatar of the first participant is to be controlled by the second participant or whether the entire avatar of the first participant is to be controlled by the second participant to complete the activity or the step of the activity is received. Control of the limb(s) or the entire avatar of the first participant is then granted to the second participant to complete the activity or the step of the activity that the first participant was unable to perform. In this manner, an activity or a step of an activity not being able to be completed in the collaborative virtual environment by an avatar of a participant can now be completed by having a different participant control the movements of the avatar to complete the activity or the step of the activity. A further discussion regarding these and other features is provided below.

In some embodiments of the present disclosure, the present disclosure comprises a computer-implemented method, system, and computer program product for controlling an avatar of a first participant by a second participant. In one embodiment of the present disclosure, a selection of an activity or a step of an activity to be performed by the avatar of the first participant in a virtual environment that the first participant needs assistance in completing is received. Furthermore, a selection of the particular limbs (e.g., right arm) of the avatar of the first participant or a selection of the entire avatar of the first participant to be controlled by the second participant to complete the activity or the step of the activity is received. Control of the one or more limbs or the entire avatar of the first participant is then granted to the second participant. In one embodiment, such control is granted by updating a data structure (e.g., table) listing the one or more participants which have control of movement of the avatars in the virtual environment (e.g., collaborative virtual environment). For example, such a data structure may be updated to reflect that not only participant #1 (the first participant) has control over the movements of avatar #1, but also participant #2 (the second participant) now has control over the movements of avatar #1, including specifying which limbs of avatar #1 or whether the entirety of avatar #1 is under the control of participant #2. In this manner, a second participant is enabled to control the movement of the limbs (e.g., hands, feet) or the entire avatar of the first participant to complete an activity or a step of an activity in situations in which the first participant is unable to complete such activity or step of the activity through his/her avatar. Consequently, digital collaboration among users is improved as an avatar of a user may be able to perform a further action in the collaborative virtual environment instead of waiting for such an activity or step of an activity to be completed.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

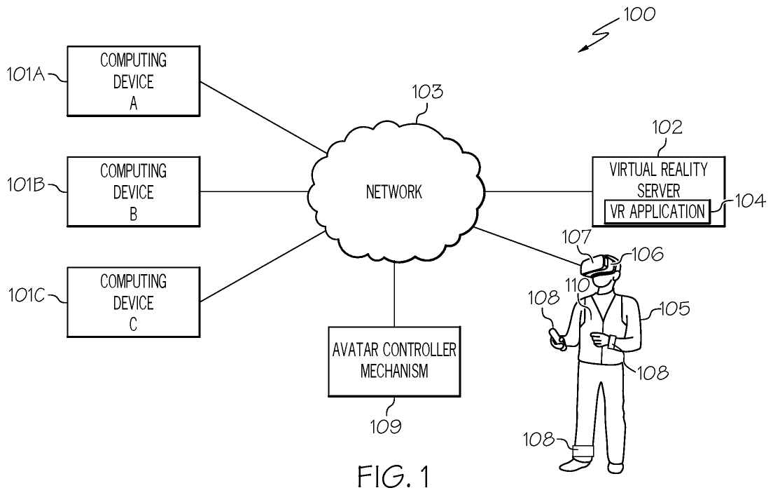

Referring now to the Figures in detail, FIG. 1 illustrates an embodiment of the present disclosure of a communication system 100 for practicing the principles of the present disclosure. Communication system 100 includes computing devices 101A-101C (identified as “Computing Device A,” “Computing Device B,” and “Computing Device C,” respectively, in FIG. 1) connected to a virtual reality server 102 via a network 103. Computing devices 101A-101C may collectively or individually be referred to as computing devices 101 or computing device 101, respectively.

Computing device 101 may be any type of computing device (e.g., portable computing unit, Personal Digital Assistant (PDA), laptop computer, mobile device, tablet personal computer, smartphone, mobile phone, navigation device, gaming unit, desktop computer system, workstation, Internet appliance and the like) configured with the capability of connecting to network 103 and consequently communicating with other computing devices 101 and virtual reality server 102. It is noted that both computing device 101 and the user of computing device 101 may be identified with element number 101.

Virtual reality server 102 hosts a virtual environment, such as a collaborative virtual environment. A collaborative virtual environment, as used herein, refers to the digital or virtual reality environment that consists of avatars and shared digital content. That is, a collaborative virtual environment is a space in which several people (e.g., users of computing devices 101) interact with each other, such as via avatars, often over several locations, in virtual reality.

In one embodiment, virtual reality server 102 includes a virtual reality (VR) application 104 configured to generate a virtual environment (e.g., collaborative virtual environment) for the users of computing devices 101. Examples of such a virtual application can include, but are not limited to, Spatial, Horizon Workrooms, Meetin VR, AltSpaceVR®, FrameVR, VIVE Sync®, etc.

Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

Furthermore, system 100 is configured to allow a user 105 (who could also be a user of computing device 101) to participate in the virtual environment (e.g., collaborative virtual environment) generated by virtual reality server 102. In one embodiment, user 105 may wear a virtual reality (VR) headset 106 that includes a display 107 providing a graphical environment for VR generation. The graphical environment includes graphical images and/or computer-generated perceptual information. Display 107 encompasses part or all of a user's field of view.

Exemplary embodiments of headset 106 include a visor, a helmet, goggles, glasses, and other similar arrangements. Examples of VR headset 106 can include, but are not limited to, Meta Quest® 2, Sony® PlayStation® V2, HTC Vive® Pro 2, Meta Quest® Pro, HP Reverb® G2, etc. Furthermore, in one embodiment, headset 106 may include any one or more of the following: headphones to provide auditory feedback, vibration means to provide vibration feedback, and other sensors placed on or around the forward-facing surface when in use.

Additionally, headset 106 may be utilized in conjunction with one or more sensors 108 configured to monitor the movements of user 105. In one embodiment, such a sensor is embodied in a wearable device. A wearable device, as used herein, refers to an electronic device designed to be worn on the body of user 105.

In one embodiment, sensors 108 include motion controllers used to track or monitor motion via the movement of the limbs of user 105, such as the user's hand(s) or the user's foot or feet. “Limbs,” as used herein, refer to the jointed, muscled appendage of user 105, such as the user's hands and feet. Examples of such motion controllers can include, but are not limited to, Oculus® Touch VR Controller, PlayStation Move® VR Controller, Samsung Gear VR® Controller, HTC Vive® VR Controller, SteelSeries® Status Duo, etc.

In one embodiment, sensors 108 include Things (IoT) sensors, which may be placed on the body of user 105 or on the clothing worn by user 105. An IoT sensor, as used herein, refers to a sensor that can be attached directly or indirectly to the body of user 105, such as via clothing. In one embodiment, IoT sensors are configured to exchange data with other devices and systems over a network, such as network 103. In one embodiment, the IoT sensor is configured to monitor the movement of user 105, such as the movement of the user's limbs. Such movement, such as the movement of the second participant designated to control the movement of the avatar of the first participant, may be captured by the IoT sensor and relayed to avatar controller mechanism 109 (discussed below) to generate the corresponding movements of the avatar, such as the avatar of the first participant, which may be implemented by virtual reality server 102. Examples of IoT sensors can include, but are not limited to, smart wearable devices, such as a smartwatch or a smart wristband.

Furthermore, as shown in FIG. 1, system 100 includes an avatar controller mechanism 109 connected to network 103. In one embodiment, avatar controller mechanism 109 is configured to enable the second participant (e.g., user of computing device 101B) to control the movement of the limbs (e.g., hands, feet) or the entire avatar of the first participant (e.g., user of computing device 101A) to complete an activity or a step of an activity in situations in which the first participant is unable to complete such activity or step of the activity through his/her avatar. A “participant,” as used herein, refers to a user, such as a user of computing device 101, user 105, who is taking part in the virtual environment (e.g., collaborative virtual environment) established by virtual reality server 102.

In one embodiment, avatar controller mechanism 109 receives a selection of an activity (e.g., planting virtual carrots in a virtual garden) or a step of an activity (e.g., moving across a room to pick-up an item, such as a virtual watering can, to water the virtual garden) to be performed by the avatar of the first participant in the virtual environment (e.g., collaborative virtual environment) that the first participant needs assistance in completing, such as by a second participant. In one embodiment, such a selection is performed by the first participant, such as user 105 or the user of computing device 101. In one embodiment, such a selection is performed via a graphical user interface, such as the graphical user interface of computing device 101.

In one embodiment, avatar controller mechanism 109 receives a selection as to the particular participant (the second participant) to control the movement of the avatar of the first participant to complete the activity or the step of the activity by the avatar. In one embodiment, such a selection is performed by the first participant, such as user 105 or the user of computing device 101. In one embodiment, such a selection is performed via a graphical user interface, such as the graphical user interface of computing device 101.

In one embodiment, avatar controller mechanism 109 displays an option to the first participant, such as on a display of computing device 101, of various eligible participants to be selected to control the movement of the avatar of the first participant so as to complete the activity or the step of the activity by the avatar. In one embodiment, such an option corresponds to a list of eligible participants which corresponds to the other users who are participating in the virtual environment (collaborative virtual environment). In one embodiment, the first participant selects one of these eligible participants to control the movement of the avatar of the first participant to complete the activity or the step of the activity by the avatar.

In one embodiment, the first participant may have pre-chosen eligible participants to control the movement of the avatar of the first participant so as to complete the activity or the step of the activity by the avatar of the first participant. In one embodiment, such pre-chosen eligible participants may be stored in a profile or a data structure (e.g., table), which may reside within the storage device of avatar controller mechanism 109.

In one embodiment, such pre-chosen eligible participants may be displayed to the first participant, such as on a display of computing device 101, in response to the first participant selecting the activity or a step of the activity to be performed by the avatar of the first participant in the virtual environment that the first participant needs assistance in completing, where the movement of such an avatar needs to be controlled by a second participant so as to complete the activity or the step of the activity. The first participant may then select one of these eligible participants to control the movement of the avatar of the first participant.

In one embodiment, avatar controller mechanism 109 receives a selection as to which limb(s) (e.g., hand, foot, etc.) of the avatar of the first participant is to be controlled by the second participant or whether the entire avatar of the first participant is to be controlled by the second participant to complete the activity or the step of the activity. In one embodiment, such a selection is performed by the first participant, such as user 105 or the user of computing device 101. In one embodiment, such a selection is performed via a graphical user interface, such as the graphical user interface of computing device 101.

In one embodiment, upon receiving the selection as to which limb(s) (e.g., hand, foot, etc.) of the avatar of the first participant is to be controlled by the second participant or whether the entire avatar of the first participant is to be controlled by the second participant, avatar controller mechanism 109 grants control of the selected limb(s) of the avatar or the entire avatar to the second participant (e.g., user of computing device 101B).

Furthermore, in one embodiment, upon granting such control of the avatar of the first participant to the second participant, avatar controller mechanism 109 accesses sensors 108 (e.g., motion controllers, IoT sensors, etc.), such as sensors embodied in a wearable device worn by user 105, that are used to monitor the movement of the second participant. For example, such monitored movements may include monitoring the movement of the user's limbs, which are to be reflected in the movements of the avatar of the first participant in the virtual environment.

Upon receiving such movements from sensors 108, in one embodiment, avatar controller mechanism 109 generates movements of the avatar of the first participant based on the received movements of the second participant. For example, if the second participant extends his/her right arm upward at a 45° angle for a total distance of 6 inches, then avatar controller mechanism 109 generates a movement of the avatar of the first participant corresponding to the right arm of the avatar being moved upward at a 45° angle for a total distance of 6 inches. In one embodiment, such generated movements are transmitted to virtual reality server 102 to be implemented by virtual reality server 102 in the virtual environment (e.g., collaborative virtual environment).

In one embodiment, avatar controller mechanism 109 determines if such movements of the second participant reflect movements of the avatar of the first participant that exceeds a boundary of the virtual reality surrounding in the virtual environment (e.g., collaborative virtual environment) if such a boundary was defined by the first participant. In one embodiment, the first participant may define a boundary of a virtual reality surrounding in the virtual environment as to the area in which the avatar of the first participant may move to complete the activity or the step of the activity. Such an area may be defined via dimensional space, such as a user-designated distance (e.g., user-designated number of feet) from a current position of the avatar in X, Y, and Z directions. In one embodiment, such a boundary is defined by the first participant, such as user 105 or the user of computing device 101, via a graphical user interface, such as the graphical user interface of computing device 101.

In one embodiment, if such movements of the second participant reflect movements of the avatar of the first participant that exceeds a defined boundary of the virtual reality surrounding in the virtual environment, then avatar controller mechanism 109 relinquishes control of the selected limbs or the entire avatar of the first participant from the second participant.

Alternatively, if such movements of the second participant reflect movements of the avatar of the first participant that do not exceed such a defined boundary of the virtual reality surrounding in the virtual environment, then avatar controller mechanism 109 generates movements of the avatar of the first participant based on the received movements of the second participant. In one embodiment, such generated movements are transmitted to virtual reality server 102 to be implemented by virtual reality server 102 in the virtual environment (e.g., collaborative virtual environment).

Avatar controller mechanism 109 is further configured to generate haptic feedback and/or visual feedback on a device(s) worn by the first and/or second participant corresponding to the movements of the avatar of the first participant.

In one embodiment, user 105 may wear a haptic device 110 configured to receive haptic feedback from avatar controller mechanism 109. Haptic feedback, as used herein, refers to the use of touch to communicate with users, such as vibration, heat, pressure, etc. For example, avatar controller mechanism 109 may generate pressure and vibrational feedback on haptic device 110, such as a haptic vest (e.g., bHaptics® TacSuit X40) worn by user 105, by issuing instructions to haptic device 110 to provide such haptic feedback corresponding to the movements of the avatar of the first participant. In another example, avatar controller mechanism 109 may generate thermoelectric effects on haptic device 110 (e.g., Teslasuit®) worn by the user, which can create temperature-based haptic experiences corresponding to the movements of the avatar of the first participant. In another example, avatar controller mechanism 109 may generate vibrotactile feedback on haptic device 110, such as virtual reality gloves (e.g., Noitom® Hi5 virtual reality glove) worn by user 105, such as by providing a range of sensations, from light touch to rough textures. In one embodiment, such vibrotactile feedback is generated on the virtual reality gloves worn by user 105 by avatar controller mechanism 109 issuing instructions to virtual reality headset 106 worn to provide such vibrotactile feedback on the virtual reality gloves. In one embodiment, avatar controller mechanism 109 manipulates the flow of electric currents between alternating conductors on the virtual reality headset 106 (one hot and one cold) so that user 105 can experience different perceived temperatures, which may reflect movements of the avatar of the first participant, such as a warm temperature for movement towards the positive X direction and a cool temperature for movement towards the negative X direction.

In one embodiment, avatar controller mechanism 109 generates visual feedback on virtual reality headset 106 corresponding to the movements of the avatar of the first participant. In one embodiment, avatar controller mechanism 109 generates instructions to virtual reality headset 106 regarding the movements of the avatar of the first participant to be reflected visually for user 105, such as on display 107 providing a graphical environment for VR generation.

A further discussion regarding these and other features is provided below.

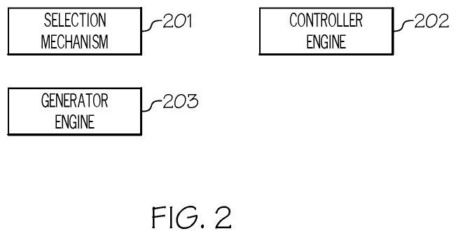

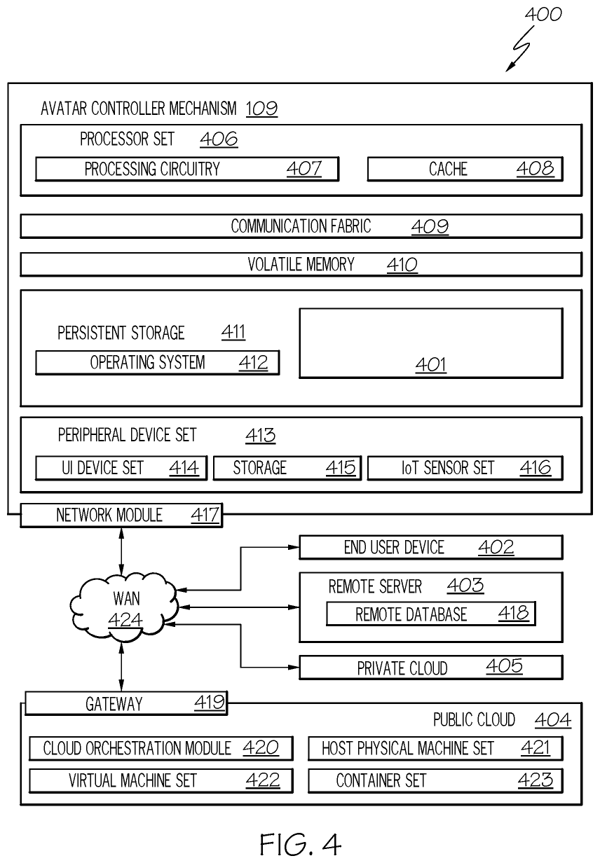

A description of the software components of avatar controller mechanism 109 for enabling the second participant (e.g., user of computing device 101B) to control the movement of the limbs (e.g., hands, feet) or the entire avatar of the first participant (e.g., user of computing device 101A) to complete an activity or a step of an activity in situations in which the first participant is unable to complete such activity or step of the activity through his/her avatar is provided below in connection with FIG. 2. A description of the hardware configuration of avatar controller mechanism 109 is provided further below in connection with FIG. 4.

System 100 is not to be limited in scope to any one particular network architecture. System 100 may include any number of computing devices 101, virtual reality servers 102, networks 103, VR applications 104, users 105, VR headsets 106, displays 107, sensors 108, avatar controller mechanisms 109, and haptic devices 110.

As discussed above, a discussion regarding the software components used by avatar controller mechanism 109 for enabling the second participant (e.g., user of computing device 101B) to control the movement of the limbs (e.g., hands, feet) or the entire avatar of the first participant (e.g., user of computing device 101A) is provided below in connection with FIG. 2.

FIG. 2 is a diagram of the software components used by avatar controller mechanism 109 for enabling the second participant (e.g., user of computing device 101B) to control the movement of the limbs (e.g., hands, feet) or the entire avatar of the first participant (e.g., user of computing device 101A) to complete an activity or a step of an activity in situations in which the first participant is unable to complete such activity or step of the activity through his/her avatar in accordance with an embodiment of the present disclosure.

Referring to FIG. 2, in conjunction with FIG. 1, avatar controller mechanism 109 includes a selection mechanism 201 configured to receive a selection of the activity (e.g., planting virtual carrots in a virtual garden) or a step of an activity (e.g., moving across a room to pick-up an item, such as a virtual watering can, to water the virtual garden) to be performed by the avatar of the first participant in the virtual environment (e.g., collaborative virtual environment) that the first participant needs assistance in completing. As a result, the movement of such an avatar needs to be controlled by a second participant so as to complete the activity or the step of the activity. A “participant,” as used herein, refers to a user, such as a user of computing device 101, user 105, who is taking part in the virtual environment (e.g., collaborative virtual environment) established by virtual reality server 102.

As discussed above, in one embodiment, such a selection is performed by the first participant, such as user 105 or the user of computing device 101. In one embodiment, such a selection is performed via a graphical user interface, such as the graphical user interface of computing device 101.

In one embodiment, selection mechanism 201 receives a selection as to the particular participant (the second participant) to control the movement of the avatar of the first participant so as to complete the activity or the step of the activity by the avatar. In one embodiment, such a selection is performed by the first participant, such as user 105 or the user of computing device 101. In one embodiment, such a selection is performed via a graphical user interface, such as the graphical user interface of computing device 101.

In one embodiment, selection mechanism 201 displays an option to the first participant, such as on a display of computing device 101, of various eligible participants to be selected to control the movement of the avatar of the first participant so as to complete the activity or the step of the activity by the avatar. In one embodiment, such an option corresponds to a list of eligible participants which corresponds to the other users who are participating in the virtual environment (collaborative virtual environment). In one embodiment, the first participant selects one of these eligible participants to control the movement of the avatar of the first participant so as to complete the activity or the step of the activity by the avatar.

In one embodiment, the first participant may have pre-chosen eligible participants to control the movement of the avatar of the first participant so as to complete the activity or the step of the activity by the avatar of the first participant. In one embodiment, such pre-chosen eligible participants may be stored in a profile or a data structure (e.g., table), which may reside within the storage device of avatar controller mechanism 109.

In one embodiment, selection mechanism 201 displays such pre-chosen eligible participants to the first participant, such as on a display of computing device 101, in response to the first participant selecting the activity or a step of the activity to be performed by the avatar of the first participant in the virtual environment that the first participant needs assistance in completing, where the movement of such an avatar needs to be controlled by a second participant so as to complete the activity or the step of the activity. The first participant may then select one of these eligible participants to control the movement of the avatar of the first participant.

In one embodiment, selection mechanism 201 receives a selection as to which limb(s) (e.g., hand, foot, etc.) of the avatar of the first participant is to be controlled by the second participant or whether the entire avatar of the first participant is to be controlled by the second participant in order to complete the activity or the step of the activity. In one embodiment, such a selection is performed by the first participant, such as user 105 or the user of computing device 101. In one embodiment, such a selection is performed via a graphical user interface, such as the graphical user interface of computing device 101.

In one embodiment, selection mechanism 201 displays an option on a display of computing device 101 of the first participant as to which limbs (e.g., left hand, right hand, left foot, right foot) are to be controlled by the second participant or whether the entire avatar is to be controlled by the second participant. Based on such a selection, which may be performed by the first participant via a graphical user interface, such as the graphical user interface of computing device 101, such information is stored in a data structure (e.g., table), which may reside within the storage device of avatar controller mechanism 109.

Furthermore, in one embodiment, selection mechanism 201 is configured to receive a boundary of a virtual reality surrounding in the virtual environment defined by the first participant as to the area in which the avatar of the first participant may move to complete the activity or the step of the activity. In one embodiment, such an area may be defined via dimensional space, such as a user-designated distance (e.g., user-designated number of feet) from a current position of the avatar in X, Y, and Z directions. In one embodiment, such a boundary is defined by the first participant, such as user 105 or the user of computing device 101, via a graphical user interface, such as the graphical user interface of computing device 101.

Avatar controller mechanism 109 further includes a controller engine 202 configured to grant control of selected limbs of the avatar of the first participant (e.g., user of computing device 101A) or the entire avatar of the first participant to the selected second participant (e.g., user of computing device 101B). In one embodiment, controller engine 202 grants such control by updating a data structure (e.g., table) listing the one or more participants which have control of the movement of the avatars identified in the virtual environment (e.g., collaborative virtual environment). For example, such a data structure may be updated to reflect that not only participant #1 (the first participant) has control over the movements of avatar #1, but also participant #2 (the second participant) now has control over the movements of avatar #1. In one embodiment, such a data structure resides within the storage device of avatar controller mechanism 109. In one embodiment, such a data structure is populated by an expert.

In one embodiment, the avatars in the virtual environment established by virtual reality server 102 are identified in the virtual environment by an identifier assigned to such avatars by virtual reality server 102. In one embodiment, such an identifier is established upon the creation of such an avatar by the participant. Furthermore, in one embodiment, such an identifier is associated with the participant that created the avatar identified by the identifier. For instance, avatar #1 is identified by identifier ABC, which is associated with participant #1 which created avatar #1, such as via participant #1's computing device's Internet Protocol address, email address, mobile phone number, etc. In one embodiment, such information is stored in the data structure discussed above, where the participant which created the avatar is automatically provided control over the movements of the created avatar.

In one embodiment, such a data structure as discussed above further specifies the specific limbs that are able to be controlled by the designated participants. For example, in one embodiment, the control of each of the limbs (e.g., right hand, left hand, right foot, left foot, etc.) of the avatar identified by an identifier is marked as enabled or not enabled for the various participants who have control over the movement of the avatar. For instance, participant #1 may have been granted control over each of the limbs of the avatar, such as the right hand, left hand, right foot, and the left foot. The control of such limbs may then be marked as enabled for participant #1 in the data structure. In another example, participant #2 may only have been granted control over the right hand. As a result, only the control of the right hand is marked as enabled for participant #2 in the data structure. The control of the other limbs, such as the left hand, the right foot, and the left foot would then be marked as disabled to prevent participant #2 from controlling such limbs.

In one embodiment, controller engine 202 grants control of particular limbs of the avatar to the second participant by enabling control of such limbs for the second participant by marking the control of such limbs as enabled for the second participant in the data structure discussed above. The control of the other limbs would be marked as disabled to prevent the second participant from controlling such limbs.

In one embodiment, such a data structure as discussed above further includes the option of designating the second participant to control the entire avatar. Controlling the entire avatar, as used herein, refers to controlling all possible movements of the avatar. In one embodiment, the data structure discussed above includes a designation of having the entire avatar controlled by designated participants. For example, in one embodiment, the control of the entire avatar identified by an identifier is marked as enabled or not enabled for the various participants who have control over the movement of the avatar. For instance, participant #1 may have been granted control over the entire avatar. As a result, the control over the entire avatar is marked as enabled for participant #1. In another example, if participant #2 has only been grated control over the right hand, then the control over the entire avatar is marked as disabled for participant #2 to prevent participant #2 from controlling the entire avatar.

Furthermore, in one embodiment, upon granting control of the avatar of the first participant to the second participant, controller engine 202 accesses sensors 108 (e.g., motion controllers, IoT sensors, etc.) of the second participant, such as sensors embodied in a wearable device worn by user 105, that are used to monitor the movement of the second participant. For example, such monitored movements may include monitoring the movement of the user's limbs, which are to be reflected in the movements of the avatar of the first participant.

Upon accessing sensors 108, controller engine 202 receives the movements of the second participant from sensors 108 to be reflected in the movements of the avatar of the first participant.

For example, if sensor 108 detects that the second participant extends his/her right arm upward at a 45° angle for a total distance of 6 inches, then such movements of the second participant are received by controller engine 202.

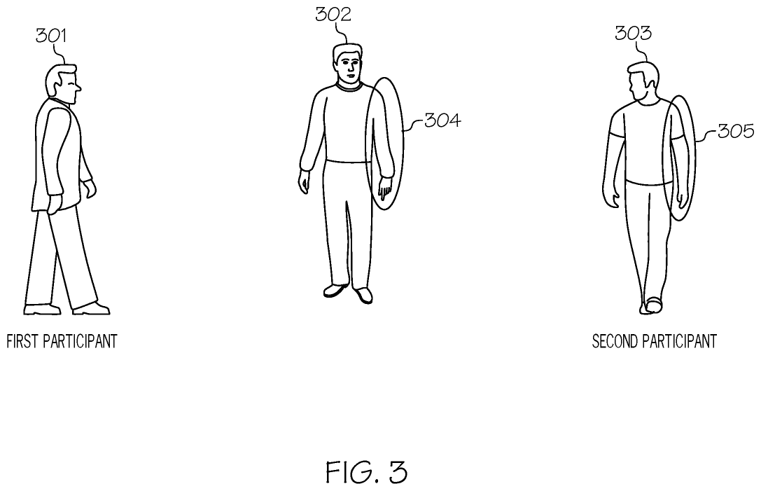

Avatar controller mechanism 109 additionally includes a generator engine 203 configured to generate movements of the avatar of the first participant based on the received movements of the second participant. For example, if the second participant extends his/her right arm upward at a 45° angle for a total distance of 6 inches, then avatar controller mechanism 109 generates a movement of the avatar of the first participant corresponding to the right arm of the avatar being moved upward at a 45° angle for a total distance of 6 inches as illustrated in FIG. 3. In one embodiment, such generated movements are transmitted to virtual reality server 102 to be implemented by virtual reality server 102 in the virtual environment (e.g., collaborative virtual environment).

Referring to FIG. 3, FIG. 3 illustrates generating movements in the avatar of the first participant based on the movements of the second participant in accordance with an embodiment of the present disclosure.

As shown in FIG. 3, in conjunction with FIGS. 1-2, the first participant 301 (e.g., user of computing device 101A) has an avatar 302 graphically representing first participant 301 or the character or persona of first participant 301. Furthermore, as illustrated in FIG. 3, controller engine 202 grants control of avatar 302 to the second participant 303 (e.g., user of computing device 101B).

In particular, as illustrated in FIG. 3, first participant 301 has selected the limb of the left arm 304 of avatar 302 to be controlled by second participant 303 to complete the activity or the step of the activity. As a result, controller engine 202 grants control of the left arm 304 of avatar 302 to second participant 303.

Upon granting control of the left arm 304 of avatar 302 to second participant 303, generator engine 203 accesses sensors 108 configured to monitor the movements of second participant 303, such as the left arm 305 of second participant 303, the movement of which corresponds to the movement of left arm 304 of avatar 302. For example, if second participant 303 extends his/her left arm 305 upward at a 45° angle for a total distance of 6 inches, then such movements are received by generator engine 203 from sensor 108 configured to monitor the movements of second participant 303.

In one embodiment, such movements may be reflected in the movements of avatar 302, such as movements in left arm 304 of avatar 302. In one embodiment, generator engine 203 generates such movements of avatar 302, such as movements in left arm 304 of avatar 302, based on the received movements of second participant 303, such as movements in left arm 305 of second participant 303.

In one embodiment, such generated movements of avatar 302 (e.g., left arm 304 of avatar 302) are transmitted to virtual reality server 102 to be implemented by virtual reality server 102. For example, upon transmitting the generated movements of avatar 302 (e.g., left arm 304 of avatar 302) to virtual reality server 102, virtual reality server 102 moves left arm 304 of avatar 302 in the virtual environment (e.g., collaborative virtual environment) upward at a 45° angle for a total distance of 6 inches.

Returning to FIG. 2, in conjunction with FIGS. 1 and 3, generator engine 203 determines if the movements of the second participant received from sensors 108 that are to be reflected in the movements of the avatar of the first participant exceeds a boundary of the virtual reality surrounding in the virtual environment (e.g., collaborative virtual environment) if such a boundary was defined by the first participant.

As previously discussed, in one embodiment, the first participant may define a boundary of a virtual reality surrounding in the virtual environment as to the area in which the avatar of the first participant may move to complete the activity or the step of the activity. Such an area may be defined via dimensional space, such as a user-designated distance (e.g., user-designated number of feet) from a current position of the avatar in X, Y, and Z directions.

In one embodiment, if such movements of the second participant reflect movements of the avatar of the first participant that exceeds a defined boundary of the virtual reality surrounding in the virtual environment, then generator engine 203 relinquishes control of the selected limbs or the entire avatar of the first participant from the second participant.

Alternatively, if such movements of the second participant reflect movements of the avatar of the first participant that do not exceed such a defined boundary of the virtual reality surrounding in the virtual environment, then generator engine 203 generates movements of the avatar of the first participant based on the received movements of the second participant. In one embodiment, such generated movements are transmitted to virtual reality server 102 to be implemented by virtual reality server 102 in the virtual environment (e.g., collaborative virtual environment).

Generator engine 203 is further configured to generate haptic feedback and/or visual feedback on a device(s) worn by the first and/or second participant corresponding to the movements of the avatar of the first participant.

As discussed above, in one embodiment, user 105 may wear a haptic device 110 configured to receive haptic feedback from avatar controller mechanism 109. Haptic feedback, as used herein, refers to the use of touch to communicate with users, such as vibration, heat, pressure, etc. For example, generator engine 203 may generate pressure and vibrational feedback on haptic device 110, such as a haptic vest (e.g., bHaptics® TacSuit X40) worn by user 105, by issuing instructions to haptic device 110 to provide such haptic feedback corresponding to the movements of the avatar of the first participant. In another example, generator engine 203 may generate thermoelectric effects on haptic device 110 (e.g., Teslasuit®) worn by the user, which can create temperature-based haptic experiences corresponding to the movements of the avatar of the first participant. In another example, generator engine 203 may generate vibrotactile feedback on haptic device 110, such as virtual reality gloves (e.g., Noitom® Hi5 virtual reality glove) worn by user 105, such as by providing a range of sensations, from light touch to rough textures. In one embodiment, such vibrotactile feedback is generated on the virtual reality gloves worn by user 105 by generator engine 203 issuing instructions to virtual reality headset 106 worn to provide such vibrotactile feedback on the virtual reality gloves. In one embodiment, generator engine 203 manipulates the flow of electric currents between alternating conductors on the virtual reality headset 106 (one hot and one cold) so that user 105 can experience different perceived temperatures, which may reflect movements of the avatar of the first participant, such as a warm temperature for movement towards the positive X direction and a cool temperature for movement towards the negative X direction.

In one embodiment, generator engine 203 generates visual feedback on virtual reality headset 106 corresponding to the movements of the avatar of the first participant. In one embodiment, generator engine 203 generates instructions to virtual reality headset 106 regarding the movements of the avatar of the first participant to be reflected visually for user 105, such as on display 107 providing a graphical environment for VR generation.

A further description of these and other features is provided below in connection with the discussion of the method for enabling the second participant (e.g., user of computing device 101B) to control the movement of the limbs (e.g., hands, feet) or the entire avatar of the first participant (e.g., user of computing device 101A) to complete an activity or a step of an activity in situations in which the first participant is unable to complete such activity or step of the activity through his/her avatar.

Prior to the discussion of the method for enabling the second participant (e.g., user of computing device 101B) to control the movement of the limbs (e.g., hands, feet) or the entire avatar of the first participant (e.g., user of computing device 101A) to complete an activity or a step of an activity in situations in which the first participant is unable to complete such activity or step of the activity through his/her avatar, a description of the hardware configuration of avatar controller mechanism 109 (FIG. 1) is provided below in connection with FIG. 4.

Referring now to FIG. 4, in conjunction with FIG. 1, FIG. 4 illustrates an embodiment of the present disclosure of the hardware configuration of avatar controller mechanism 109 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code (stored in block 401) involved in performing the disclosed methods, such as enabling the second participant (e.g., user of computing device 101B) to control the movement of the limbs (e.g., hands, feet) or the entire avatar of the first participant (e.g., user of computing device 101A) to complete an activity or a step of an activity in situations in which the first participant is unable to complete such activity or step of the activity through his/her avatar. In addition to block 401, computing environment 400 includes, for example, avatar controller mechanism 109, wide area network (WAN) 424 (in one embodiment, WAN 424 corresponds to network 103 of FIG. 1), end user device (EUD) 402, remote server 403, public cloud 404, and private cloud 405. In this embodiment, avatar controller mechanism 109 includes processor set 406 (including processing circuitry 407 and cache 408), communication fabric 409, volatile memory 410, persistent storage 411 (including operating system 412 and block 401, as identified above), peripheral device set 413 (including user interface (UI) device set 414, storage 415, and Internet of Things (IoT) sensor set 416), and network module 417. Remote server 403 includes remote database 418. Public cloud 404 includes gateway 419, cloud orchestration module 420, host physical machine set 421, virtual machine set 422, and container set 423.

Avatar controller mechanism 109 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 418. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically avatar controller mechanism 109, to keep the presentation as simple as possible. Avatar controller mechanism 109 may be located in a cloud, even though it is not shown in a cloud in FIG. 4. On the other hand, avatar controller mechanism 109 is not required to be in a cloud except to any extent as may be affirmatively indicated.

Processor set 406 includes one, or more, computer processors of any type now known or to be developed in the future. Processing circuitry 407 may be distributed over multiple packages, for example, multiple, coordinated integrated circuit chips. Processing circuitry 407 may implement multiple processor threads and/or multiple processor cores. Cache 408 is memory that is located in the processor chip package(s) and is typically used for data or code that should be available for rapid access by the threads or cores running on processor set 406. Cache memories are typically organized into multiple levels depending upon relative proximity to the processing circuitry. Alternatively, some, or all, of the cache for the processor set may be located “off chip.” In some computing environments, processor set 406 may be designed for working with qubits and performing quantum computing.

Computer readable program instructions are typically loaded onto avatar controller mechanism 109 to cause a series of operational steps to be performed by processor set 406 of avatar controller mechanism 109 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 408 and the other storage media discussed below. The program instructions, and associated data, are accessed by processor set 406 to control and direct performance of the disclosed methods. In computing environment 400, at least some of the instructions for performing the disclosed methods may be stored in block 401 in persistent storage 411.

Communication fabric 409 is the signal conduction paths that allow the various components of avatar controller mechanism 109 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 410 is any type of volatile memory now known or to be developed in the future. Examples include dynamic type random access memory (RAM) or static type RAM. Typically, the volatile memory is characterized by random access, but this is not required unless affirmatively indicated. In avatar controller mechanism 109, the volatile memory 410 is located in a single package and is internal to avatar controller mechanism 109, but, alternatively or additionally, the volatile memory may be distributed over multiple packages and/or located externally with respect to avatar controller mechanism 109.

Persistent Storage 411 is any form of non-volatile storage for computers that is now known or to be developed in the future. The non-volatility of this storage means that the stored data is maintained regardless of whether power is being supplied to avatar controller mechanism 109 and/or directly to persistent storage 411. Persistent storage 411 may be a read only memory (ROM), but typically at least a portion of the persistent storage allows writing of data, deletion of data and re-writing of data. Some familiar forms of persistent storage include magnetic disks and solid-state storage devices. Operating system 412 may take several forms, such as various known proprietary operating systems or open-source Portable Operating System Interface type operating systems that employ a kernel. The code included in block 401 typically includes at least some of the computer code involved in performing the disclosed methods.

Peripheral device set 413 includes the set of peripheral devices of avatar controller mechanism 109. Data communication connections between the peripheral devices and the other components of avatar controller mechanism 109 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 414 may include components such as a display screen, speaker, microphone, wearable devices (such as goggles and smart watches), keyboard, mouse, printer, touchpad, game controllers, and haptic devices. Storage 415 is external storage, such as an external hard drive, or insertable storage, such as an SD card. Storage 415 may be persistent and/or volatile. In some embodiments, storage 415 may take the form of a quantum computing storage device for storing data in the form of qubits. In embodiments where avatar controller mechanism 109 is required to have a large amount of storage (for example, where avatar controller mechanism 109 locally stores and manages a large database) then this storage may be provided by peripheral storage devices designed for storing very large amounts of data, such as a storage area network (SAN) that is shared by multiple, geographically distributed computers. IoT sensor set 416 is made up of sensors that can be used in Internet of Things applications. For example, one sensor may be a thermometer and another sensor may be a motion detector.

Network module 417 is the collection of computer software, hardware, and firmware that allows avatar controller mechanism 109 to communicate with other computers through WAN 424. Network module 417 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 417 are performed on the same physical hardware device. In other embodiments (for example, embodiments that utilize software-defined networking (SDN)), the control functions and the forwarding functions of network module 417 are performed on physically separate devices, such that the control functions manage several different network hardware devices. Computer readable program instructions for performing the disclosed methods can typically be downloaded to avatar controller mechanism 109 from an external computer or external storage device through a network adapter card or network interface included in network module 417.

WAN 424 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 402 is any computer system that is used and controlled by an end user (for example, a customer of an enterprise that operates avatar controller mechanism 109) and may take any of the forms discussed above in connection with avatar controller mechanism 109. EUD 402 typically receives helpful and useful data from the operations of avatar controller mechanism 109. For example, in a hypothetical case where avatar controller mechanism 109 is designed to provide a recommendation to an end user, this recommendation would typically be communicated from network module 417 of avatar controller mechanism 109 through WAN 424 to EUD 402. In this way, EUD 402 can display, or otherwise present, the recommendation to an end user. In some embodiments, EUD 402 may be a client device, such as thin client, heavy client, mainframe computer, desktop computer and so on.

Remote server 403 is any computer system that serves at least some data and/or functionality to avatar controller mechanism 109. Remote server 403 may be controlled and used by the same entity that operates avatar controller mechanism 109. Remote server 403 represents the machine(s) that collect and store helpful and useful data for use by other computers, such as avatar controller mechanism 109. For example, in a hypothetical case where avatar controller mechanism 109 is designed and programmed to provide a recommendation based on historical data, then this historical data may be provided to avatar controller mechanism 109 from remote database 418 of remote server 403.

Public cloud 404 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 404 is performed by the computer hardware and/or software of cloud orchestration module 420. The computing resources provided by public cloud 404 are typically implemented by virtual computing environments that run on various computers making up the computers of host physical machine set 421, which is the universe of physical computers in and/or available to public cloud 404. The virtual computing environments (VCEs) typically take the form of virtual machines from virtual machine set 422 and/or containers from container set 423. It is understood that these VCEs may be stored as images and may be transferred among and between the various physical machine hosts, either as images or after instantiation of the VCE. Cloud orchestration module 420 manages the transfer and storage of images, deploys new instantiations of VCEs and manages active instantiations of VCE deployments. Gateway 419 is the collection of computer software, hardware, and firmware that allows public cloud 404 to communicate through WAN 424.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 405 is similar to public cloud 404, except that the computing resources are only available for use by a single enterprise. While private cloud 405 is depicted as being in communication with WAN 424 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 404 and private cloud 405 are both part of a larger hybrid cloud.

Block 401 further includes the software components discussed above in connection with FIGS. 2-3 to enable the second participant (e.g., user of computing device 101B) to control the movement of the limbs (e.g., hands, feet) or the entire avatar of the first participant (e.g., user of computing device 101A) to complete an activity or a step of an activity in situations in which the first participant is unable to complete such activity or step of the activity through his/her avatar. In one embodiment, such components may be implemented in hardware. The functions discussed above performed by such components are not generic computer functions. As a result, avatar controller mechanism 109 is a particular machine that is the result of implementing specific, non-generic computer functions.

In one embodiment, the functionality of such software components of avatar controller mechanism 109, including the functionality for enabling the second participant (e.g., user of computing device 101B) to control the movement of the limbs (e.g., hands, feet) or the entire avatar of the first participant (e.g., user of computing device 101A) to complete an activity or a step of an activity in situations in which the first participant is unable to complete such activity or step of the activity through his/her avatar, may be embodied in an application specific integrated circuit.

As stated above, virtual reality (VR) is a simulated experience that employs pose tracking and three-dimensional (3D) near-eye displays to give the user an immersive feel of a virtual world. Applications of virtual reality include entertainment (particularly video games), education (such as medical or military training) and business (such as virtual meetings). Other distinct types of VR-style technology include augmented reality and mixed reality, sometimes referred to as extended reality or XR. Currently, standard virtual reality systems use either virtual reality headsets or multi-projected environments to generate some realistic images, sounds, and other sensations that simulate a user's physical presence in a virtual environment. A person using virtual reality equipment is able to look around the artificial world, move around in it, and interact with virtual features or items. The effect is commonly created by VR headsets consisting of a head-mounted display with a small screen in front of the eyes but can also be created through specially designed rooms with multiple large screens. Virtual reality typically incorporates auditory and video feedback but may also allow other types of sensory and force feedback through haptic technology. Examples of utilizing virtual reality in such collaborative virtual environments include virtual meeting rooms where avatars of employees can connect to discuss challenges, work on projects, and tackle complex tasks as well as virtual building environments, where employees can design new products and experiment with designs in a three-dimensional environment. Other examples include training spaces designed to replicate real-life environments that would be dangerous or difficult for team members to access in reality, sales environments where employees can introduce customers to the features and capabilities of products for better onboarding and value demonstrations, and social spaces where remote workers can come together to learn new things, share information, and strengthen bonds. In such collaborative virtual environments, each user will be represented by an avatar, which is a graphical representation of the user or the user's character or persona. Based on the actions of the user, the avatar may perform corresponding actions (e.g., movements) in the collaborative virtual environment. At times though, the user, and by extension the user's avatar, may not be able to perform such actions, such as an activity (e.g., planting virtual carrots in a virtual garden) or a step of an activity (e.g., moving across a room to pick-up an item, such as a virtual watering can, to water the virtual garden). As a result, by the avatar not being able to complete the activity or step of an activity in the collaborative virtual environment, the digital collaboration among users becomes limited. For example, an avatar of a user may be waiting for such an activity or step of an activity to be completed prior to performing a further action in the collaborative virtual environment.

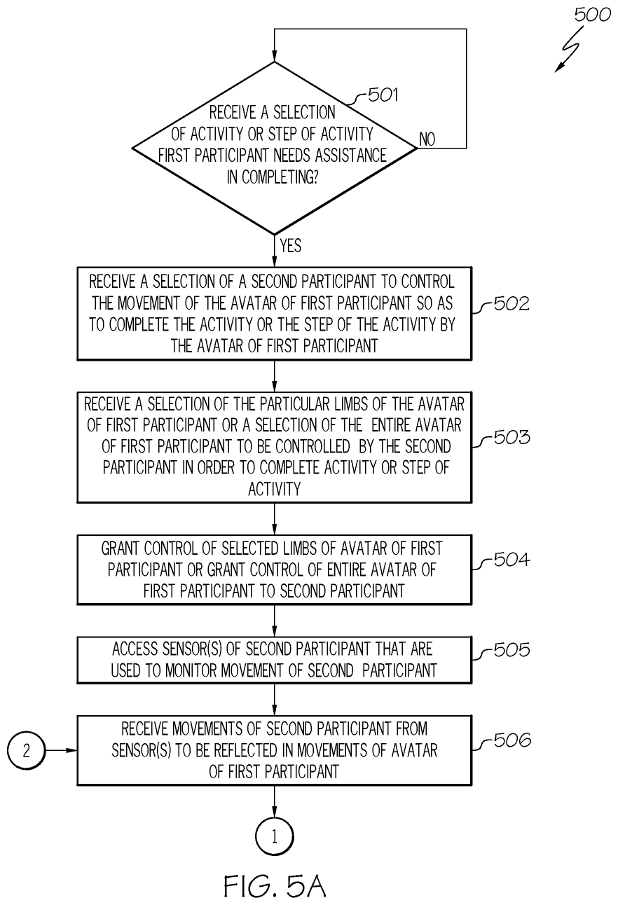

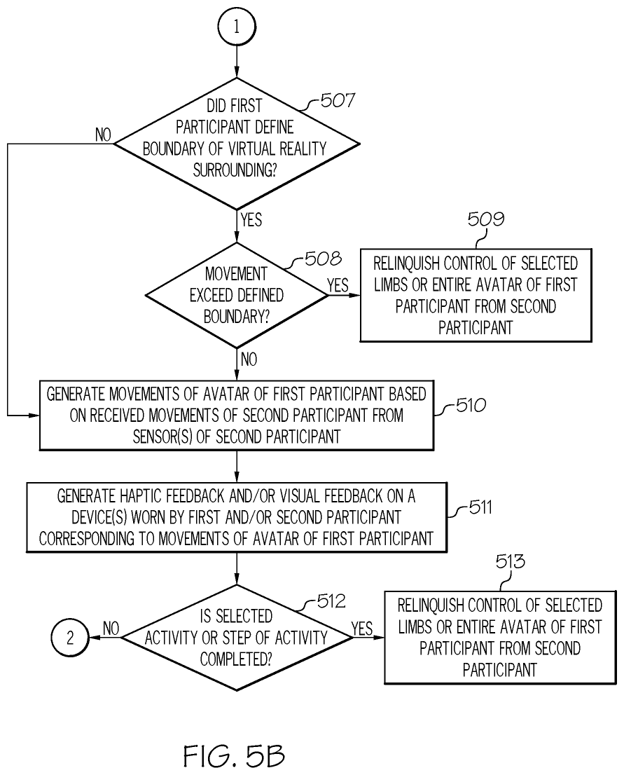

The embodiments of the present disclosure provide a means for controlling an avatar of a first participant by a second participant in the collaborative virtual environment as discussed below in connection with FIGS. 5A-5B.

FIGS. 5A-5B are a flowchart of a method 500 for enabling the second participant (e.g., user of computing device 101B) to control the movement of the limbs (e.g., hands, feet) or the entire avatar of the first participant (e.g., user of computing device 101A) to complete an activity or a step of an activity in situations in which the first participant is unable to complete such activity or step of the activity through his/her avatar in accordance with an embodiment of the present disclosure.

Referring to FIG. 5A, in conjunction with FIGS. 1-4, in operation 501, selection mechanism 201 of avatar controller mechanism 109 determines whether a selection of an activity or a step of an activity that the first participant (e.g., user of computing device 101A) needs assistance in completing has been received.

As discussed above, selection mechanism 201 determines whether a selection of an activity (e.g., planting virtual carrots in a virtual garden) or a step of an activity (e.g., moving across a room to pick-up an item, such as a virtual watering can, to water the virtual garden) to be performed by the avatar of the first participant in the virtual environment (e.g., collaborative virtual environment) has been received, where the movement of such an avatar needs to be controlled by a second participant so as to complete the activity or the step of the activity.

In one embodiment, such a selection is performed by the first participant, such as user 105 or the user of computing device 101. In one embodiment, such a selection is performed via a graphical user interface, such as the graphical user interface of computing device 101.

If selection mechanism 201 has not received such a selection of an activity or a step of an activity that the first participant (e.g., user of computing device 101A) needs assistance in completing, then selection mechanism 201 of avatar controller mechanism 109 continues to determine whether a selection of an activity or a step of an activity that the first participant (e.g., user of computing device 101A) needs assistance in completing has been received in operation 501.

If, however, selection mechanism 201 has received such a selection of an activity or a step of an activity that the first participant (e.g., user of computing device 101A) needs assistance in completing, then selection mechanism 201 of avatar controller mechanism 109 receives a selection as to the particular participant (the second participant) to control the movement of the avatar of the first participant so as to complete the activity or the step of the activity by the avatar of the first participant.

As discussed above, in one embodiment, such a selection is performed by the first participant, such as user 105 or the user of computing device 101. In one embodiment, such a selection is performed via a graphical user interface, such as the graphical user interface of computing device 101.

In one embodiment, selection mechanism 201 displays an option to the first participant, such as on a display of computing device 101, of various eligible participants to be selected to control the movement of the avatar of the first participant so as to complete the activity or the step of the activity by the avatar. In one embodiment, such an option corresponds to a list of eligible participants which corresponds to the other users who are participating in the virtual environment (collaborative virtual environment). In one embodiment, the first participant selects one of these eligible participants to control the movement of the avatar of the first participant so as to complete the activity or the step of the activity by the avatar.

In one embodiment, the first participant may have pre-chosen eligible participants to control the movement of the avatar of the first participant so as to complete the activity or the step of the activity by the avatar of the first participant. In one embodiment, such pre-chosen eligible participants may be stored in a profile or a data structure (e.g., table), which may reside within the storage device (e.g., storage device 411, 415) of avatar controller mechanism 109.

In one embodiment, selection mechanism 201 displays such pre-chosen eligible participants to the first participant, such as on a display of computing device 101, in response to the first participant selecting the activity or a step of the activity to be performed by the avatar of the first participant in the virtual environment that the first participant needs assistance in completing, where the movement of such an avatar needs to be controlled by a second participant so as to complete the activity or the step of the activity. The first participant may then select one of these eligible participants to control the movement of the avatar of the first participant.

In operation 503, selection mechanism 201 of avatar controller mechanism 109 receives a selection of the particular limbs of the avatar of the first participant or a selection of the entire avatar of the first participant to be controlled by the second participant in order to complete the activity or the step of the activity.

As stated above, in one embodiment, such a selection is performed by the first participant, such as user 105 or the user of computing device 101. In one embodiment, such a selection is performed via a graphical user interface, such as the graphical user interface of computing device 101.

In one embodiment, selection mechanism 201 displays an option on a display of computing device 101 of the first participant as to which limbs (e.g., left hand, right hand, left foot, right foot) are to be controlled by the second participant or whether the entire avatar is to be controlled by the second participant. Based on such a selection, which may be performed by the first participant via a graphical user interface, such as the graphical user interface of computing device 101, such information is stored in a data structure (e.g., table), which may reside within the storage device (e.g., storage device 411, 415) of avatar controller mechanism 109.

In operation 504, controller engine 202 of avatar controller mechanism 109 grants control of the selected limbs of the avatar of the first participant (e.g., user of computing device 101A) or the entire avatar of the first participant to the selected second participant (e.g., user of computing device 101B) based on the selection received from the first participant in operation 503.

As stated above, in one embodiment, controller engine 202 grants such control by updating a data structure (e.g., table) listing the one or more participants which have control of the movement of the avatars identified in the virtual environment (e.g., collaborative virtual environment). For example, such a data structure may be updated to reflect that not only participant #1 (the first participant) has control over the movements of avatar #1, but also participant #2 (the second participant) now has control over the movements of avatar #1. In one embodiment, such a data structure resides within the storage device (e.g., storage device 411, 415) of avatar controller mechanism 109. In one embodiment, such a data structure is populated by an expert.

In one embodiment, the avatars in the virtual environment established by virtual reality server 102 are identified in the virtual environment by an identifier assigned to such avatars by virtual reality server 102. In one embodiment, such an identifier is established upon the creation of such an avatar by the participant. Furthermore, in one embodiment, such an identifier is associated with the participant that created the avatar identified by the identifier. For instance, avatar #1 is identified by identifier ABC, which is associated with participant #1 which created avatar #1, such as via participant #1's computing device's Internet Protocol address, email address, mobile phone number, etc. In one embodiment, such information is stored in the data structure discussed above, where the participant which created the avatar is automatically provided control over the movements of the created avatar.

In one embodiment, such a data structure as discussed above further specifies the specific limbs that are able to be controlled by the designated participants. For example, in one embodiment, the control of each of the limbs (e.g., right hand, left hand, right foot, left foot, etc.) of the avatar identified by an identifier is marked as enabled or not enabled for the various participants who have control over the movement of the avatar. For instance, participant #1 may have been granted control over each of the limbs of the avatar, such as the right hand, left hand, right foot, and the left foot. The control of such limbs may then be marked as enabled for participant #1 in the data structure. In another example, participant #2 may only have been granted control over the right hand. As a result, only the control of the right hand is marked as enabled for participant #2 in the data structure. The control of the other limbs, such as the left hand, the right foot, and the left foot would then be marked as disabled to prevent participant #2 from controlling such limbs.

In one embodiment, controller engine 202 grants control of particular limbs of the avatar to the second participant by enabling control of such limbs for the second participant by marking the control of such limbs as enabled for the second participant in the data structure discussed above. The control of the other limbs would be marked as disabled to prevent the second participant from controlling such limbs.

In one embodiment, such a data structure as discussed above further includes the option of designating the second participant to control the entire avatar. Controlling the entire avatar, as used herein, refers to controlling all possible movements of the avatar. In one embodiment, the data structure discussed above includes a designation of having the entire avatar controlled by designated participants. For example, in one embodiment, the control of the entire avatar identified by an identifier is marked as enabled or not enabled for the various participants who have control over the movement of the avatar. For instance, participant #2 may have been granted control over the entire avatar. As a result, the control over the entire avatar is marked as enabled for participant #2. In another example, if participant #2 has only been grated control over the right hand, then the control over the entire avatar is marked as disabled for participant #2 to prevent participant #2 from controlling the entire avatar.

In operation 505, upon granting control of the avatar of the first participant to the second participant, controller engine 202 of avatar controller mechanism 109 accesses the sensor(s) 108 (e.g., motion controllers, IoT sensors, etc.) of the second participant, such as sensors embodied in a wearable device worn by user 105, that are used to monitor the movement of the second participant. For example, such monitored movements may include monitoring the movement of the user's limbs, which are to be reflected in the movements of the avatar of the first participant.

Upon accessing the sensor(s) 108, in operation 506, controller engine 202 of avatar controller mechanism 109 receives the movements of the second participant from the sensor(s) 108 to be reflected in the movements of the avatar of the first participant.

For example, if sensor 108 detects that the second participant extends his/her right arm upward at a 45° angle for a total distance of 6 inches, then such movements of the second participant are received by controller engine 202.

Referring now to FIG. 5B, in conjunction with FIGS. 1-4, in operation 507, generator engine 203 of avatar controller mechanism 109 determines whether the first participant defined a boundary of the virtual reality surrounding in the virtual environment (e.g., collaborative virtual environment).

As discussed above, in one embodiment, selection mechanism 201 is configured to receive a boundary of a virtual reality surrounding in the virtual environment defined by the first participant as to the area in which the avatar of the first participant may move to complete the activity or the step of the activity. In one embodiment, such an area may be defined via dimensional space, such as a user-designated distance (e.g., user-designated number of feet) from a current position of the avatar in X, Y, and Z directions. In one embodiment, such a boundary is defined by the first participant, such as user 105 or the user of computing device 101, via a graphical user interface, such as the graphical user interface of computing device 101.

If a defined boundary of the virtual reality surrounding in the virtual environment (e.g., collaborative virtual environment) was received by selection mechanism 201, then, in operation 508, generator engine 203 of avatar controller mechanism 109 determines if the movements of the second participant received from sensors 108 that are to be reflected in the movements of the avatar of the first participant exceeds a boundary of the virtual reality surrounding in the virtual environment (e.g., collaborative virtual environment).

As previously discussed, in one embodiment, the first participant may define a boundary of a virtual reality surrounding in the virtual environment as to the area in which the avatar of the first participant may move to complete the activity or the step of the activity. Such an area may be defined via dimensional space, such as a user-designated distance (e.g., user-designated number of feet) from a current position of the avatar in X, Y, and Z directions.

In one embodiment, if such movements of the second participant reflect movements of the avatar of the first participant that exceeds a defined boundary of the virtual reality surrounding in the virtual environment, then, in operation 509, generator engine 203 of avatar controller mechanism 109 relinquishes control of the selected limbs or the entire avatar of the first participant from the second participant.

Alternatively, if such movements of the second participant reflect movements of the avatar of the first participant that do not exceed such a defined boundary of the virtual reality surrounding in the virtual environment, or if a defined boundary of the virtual reality surrounding in the virtual environment (e.g., collaborative virtual environment) was not received by selection mechanism 201, then, in operation 510, generator engine 203 of avatar controller mechanism 109 generates movements of the avatar of the first participant based on the received movements of the second participant (received in operation 506 from sensor(s) 108). In one embodiment, such generated movements are transmitted to virtual reality server 102 to be implemented by virtual reality server 102 in the virtual environment (e.g., collaborative virtual environment).

As discussed above, for example, if the second participant extends his/her right arm upward at a 45° angle for a total distance of 6 inches, then avatar controller mechanism 109 generates a movement of the avatar of the first participant corresponding to the right arm of the avatar being moved upward at a 45° angle for a total distance of 6 inches as illustrated in FIG. 3. In one embodiment, such generated movements are transmitted to virtual reality server 102 to be implemented by virtual reality server 102 in the virtual environment (e.g., collaborative virtual environment).

As shown in FIG. 3, the first participant 301 (e.g., user of computing device 101A) has an avatar 302 graphically representing first participant 301 or the character or persona of first participant 301. Furthermore, as illustrated in FIG. 3, controller engine 202 grants control of avatar 302 to the second participant 303 (e.g., user of computing device 101B).

In particular, as illustrated in FIG. 3, first participant 301 has selected the limb of the left arm 304 of avatar 302 to be controlled by second participant 303 to complete the activity or the step of the activity. As a result, controller engine 202 grants control of the left arm 304 of avatar 302 to second participant 303.

Upon granting control of the left arm 304 of avatar 302 to second participant 303, generator engine 203 accesses sensors 108 configured to monitor the movements of second participant 303, such as the left arm 305 of second participant 303, the movement of which corresponds to the movement of left arm 304 of avatar 302. For example, if second participant 303 extends his/her left arm 305 upward at a 45° angle for a total distance of 6 inches, then such movements are received by generator engine 203 from sensor 108 configured to monitor the movements of second participant 303.

In one embodiment, such movements may be reflected in the movements of avatar 302, such as movements in left arm 304 of avatar 302. In one embodiment, generator engine 203 generates such movements of avatar 302, such as movements in left arm 304 of avatar 302, based on the received movements of second participant 303, such as movements in left arm 305 of second participant 303.

In one embodiment, such generated movements of avatar 302 (e.g., left arm 304 of avatar 302) are transmitted to virtual reality server 102 to be implemented by virtual reality server 102 in the virtual environment. For example, upon transmitting the generated movements of avatar 302 (e.g., left arm 304 of avatar 302) to virtual reality server 102, virtual reality server 102 moves left arm 304 of avatar 302 in the virtual environment (e.g., collaborative virtual environment) upward at a 45° angle for a total distance of 6 inches.

Returning to FIG. 5B, in conjunction with FIGS. 1-4, in operation 511, generator engine 203 of avatar controller mechanism 109 generates haptic feedback and/or visual feedback on a device(s) worn by the first and/or second participant corresponding to the movements of the avatar of the first participant.

As discussed above, in one embodiment, user 105 may wear a haptic device 110 configured to receive haptic feedback from avatar controller mechanism 109. Haptic feedback, as used herein, refers to the use of touch to communicate with users, such as vibration, heat, pressure, etc. For example, generator engine 203 may generate pressure and vibrational feedback on haptic device 110, such as a haptic vest (e.g., bHaptics® TacSuit X40) worn by user 105, by issuing instructions to haptic device 110 to provide such haptic feedback corresponding to the movements of the avatar of the first participant. In another example, generator engine 203 may generate thermoelectric effects on haptic device 110 (e.g., Teslasuit®) worn by the user, which can create temperature-based haptic experiences corresponding to the movements of the avatar of the first participant. In another example, generator engine 203 may generate vibrotactile feedback on haptic device 110, such as virtual reality gloves (e.g., Noitom® Hi5 virtual reality glove) worn by user 105, such as by providing a range of sensations, from light touch to rough textures. In one embodiment, such vibrotactile feedback is generated on the virtual reality gloves worn by user 105 by generator engine 203 issuing instructions to virtual reality headset 106 worn to provide such vibrotactile feedback on the virtual reality gloves. In one embodiment, generator engine 203 manipulates the flow of electric currents between alternating conductors on the virtual reality headset 106 (one hot and one cold) so that user 105 can experience different perceived temperatures, which may reflect movements of the avatar of the first participant, such as a warm temperature for movement towards the positive X direction and a cool temperature for movement towards the negative X direction.

In one embodiment, generator engine 203 generates visual feedback on virtual reality headset 106 corresponding to the movements of the avatar of the first participant. In one embodiment, generator engine 203 generates instructions to virtual reality headset 106 regarding the movements of the avatar of the first participant to be reflected visually for user 105, such as on display 107 providing a graphical environment for VR generation.

In operation 512, generator engine 203 of avatar controller mechanism 109 determines if the selected activity or the step of the activity (selected by the first participant in operation 501) has been completed.

If the selected activity or the step of the activity has been completed, then, in operation 513, generator engine 203 of avatar controller mechanism 109 relinquishes control of the selected limbs or the entire avatar of the first participant from the second participant.

If, however, the selected activity or the step of the activity has not been completed, then controller engine 202 of avatar controller mechanism 109 continues to receive the movements of the second participant from the sensor(s) 108 to be reflected in the movements of the avatar of the first participant in operation 506.

As a result of the foregoing, a second participant is enabled to control the movement of the limbs (e.g., hands, feet) or the entire avatar of the first participant to complete an activity or a step of an activity in situations in which the first participant is unable to complete such activity or step of the activity through his/her avatar. Consequently, digital collaboration among users is improved as an avatar of a user may be able to perform a further action in the collaborative virtual environment instead of waiting for such an activity or step of an activity to be completed.

Furthermore, the principles of the present disclosure improve the technology or technical field involving collaborative virtual environments.

As discussed above, virtual reality (VR) is a simulated experience that employs pose tracking and three-dimensional (3D) near-eye displays to give the user an immersive feel of a virtual world. Applications of virtual reality include entertainment (particularly video games), education (such as medical or military training) and business (such as virtual meetings). Other distinct types of VR-style technology include augmented reality and mixed reality, sometimes referred to as extended reality or XR. Currently, standard virtual reality systems use either virtual reality headsets or multi-projected environments to generate some realistic images, sounds, and other sensations that simulate a user's physical presence in a virtual environment. A person using virtual reality equipment is able to look around the artificial world, move around in it, and interact with virtual features or items. The effect is commonly created by VR headsets consisting of a head-mounted display with a small screen in front of the eyes but can also be created through specially designed rooms with multiple large screens. Virtual reality typically incorporates auditory and video feedback but may also allow other types of sensory and force feedback through haptic technology. Examples of utilizing virtual reality in such collaborative virtual environments include virtual meeting rooms where avatars of employees can connect to discuss challenges, work on projects, and tackle complex tasks as well as virtual building environments, where employees can design new products and experiment with designs in a three-dimensional environment. Other examples include training spaces designed to replicate real-life environments that would be dangerous or difficult for team members to access in reality, sales environments where employees can introduce customers to the features and capabilities of products for better onboarding and value demonstrations, and social spaces where remote workers can come together to learn new things, share information, and strengthen bonds. In such collaborative virtual environments, each user will be represented by an avatar, which is a graphical representation of the user or the user's character or persona. Based on the actions of the user, the avatar may perform corresponding actions (e.g., movements) in the collaborative virtual environment. At times though, the user, and by extension the user's avatar, may not be able to perform such actions, such as an activity (e.g., planting virtual carrots in a virtual garden) or a step of an activity (e.g., moving across a room to pick-up an item, such as a virtual watering can, to water the virtual garden). As a result, by the avatar not being able to complete the activity or step of an activity in the collaborative virtual environment, the digital collaboration among users becomes limited. For example, an avatar of a user may be waiting for such an activity or step of an activity to be completed prior to performing a further action in the collaborative virtual environment.

Embodiments of the present disclosure improve such technology by receiving a selection of an activity or a step of an activity to be performed by the avatar of the first participant in a virtual environment that the first participant needs assistance in completing. Furthermore, a selection of the particular limbs (e.g., right arm) of the avatar of the first participant or a selection of the entire avatar of the first participant to be controlled by the second participant to complete the activity or the step of the activity is received. Control of the one or more limbs or the entire avatar of the first participant is then granted to the second participant. In one embodiment, such control is granted by updating a data structure (e.g., table) listing the one or more participants which have control of movement of the avatars in the virtual environment (e.g., collaborative virtual environment). For example, such a data structure may be updated to reflect that not only participant #1 (the first participant) has control over the movements of avatar #1, but also participant #2 (the second participant) now has control over the movements of avatar #1, including specifying which limbs of avatar #1 or whether the entirety of avatar #1 is under the control of participant #2. In this manner, a second participant is enabled to control the movement of the limbs (e.g., hands, feet) or the entire avatar of the first participant to complete an activity or a step of an activity in situations in which the first participant is unable to complete such activity or step of the activity through his/her avatar. Consequently, digital collaboration among users is improved as an avatar of a user may be able to perform a further action in the collaborative virtual environment instead of waiting for such an activity or step of an activity to be completed. Furthermore, in this manner, there is an improvement in the technical field involving collaborative virtual environments.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for controlling an avatar of a first participant by a second participant, the method comprising:
receiving a selection of an activity or a step of said activity to be performed by said avatar of said first participant in a virtual environment that said first participant needs assistance in completing;
receiving a selection of one or more limbs of said avatar of said first participant or a selection of an entirety of said avatar of said first participant to be controlled by said second participant to complete said activity or said step of said activity; and
granting control of said one or more limbs or said entirety of said avatar of said first participant to said second participant.

2. The computer-implemented method as recited in claim 1 further comprising:
accessing one or more sensors configured to monitor movements of said second participant to control said one or more limbs or said entirety of said avatar of said first participant.

3. The computer-implemented method as recited in claim 2 further comprising:
receiving movements of said second participant from said one or more sensors to be reflected in movements of said avatar of said first participant.

4. The computer-implemented method as recited in claim 3 further comprising:
receiving a defined boundary of a virtual reality surrounding in said virtual environment.

5. The computer-implemented method as recited in claim 4 further comprising:
generating movements of said avatar of said first participant based on said received movements of said second participant in response to said movements of said avatar of said first participant not exceeding said defined boundary of said virtual reality surrounding in said virtual environment.

6. The computer-implemented method as recited in claim 5 further comprising:
generating haptic feedback and/or visual feedback on a device worn by said first participant and/or said second participant corresponding to said movements of said avatar of said first participant.

7. The computer-implemented method as recited in claim 4 further comprising:
relinquishing control of said one or more limbs or said entirety of said avatar of said first participant by said second participant in response to said received movements of said second participant resulting in movements of said avatar of said first participant exceeding said defined boundary of said virtual reality surrounding in said virtual environment.

8. The computer-implemented method as recited in claim 1 further comprising:
relinquishing control of said one or more limbs or said entirety of said avatar of said first participant by said second participant in response to completion of said activity or said step of said activity performed by said avatar of said first participant in said virtual environment.

9. A computer program product for controlling an avatar of a first participant by a second participant, the computer program product comprising one or more computer readable storage mediums having program code embodied therewith, the program code comprising programming instructions for:
receiving a selection of an activity or a step of said activity to be performed by said avatar of said first participant in a virtual environment that said first participant needs assistance in completing;
receiving a selection of one or more limbs of said avatar of said first participant or a selection of an entirety of said avatar of said first participant to be controlled by said second participant to complete said activity or said step of said activity; and
granting control of said one or more limbs or said entirety of said avatar of said first participant to said second participant.

10. The computer program product as recited in claim 9, wherein the program code further comprises the programming instructions for:
accessing one or more sensors configured to monitor movements of said second participant to control said one or more limbs or said entirety of said avatar of said first participant.

11. The computer program product as recited in claim 10, wherein the program code further comprises the programming instructions for:
receiving movements of said second participant from said one or more sensors to be reflected in movements of said avatar of said first participant.

12. The computer program product as recited in claim 11, wherein the program code further comprises the programming instructions for:
receiving a defined boundary of a virtual reality surrounding in said virtual environment.

13. The computer program product as recited in claim 12, wherein the program code further comprises the programming instructions for:
generating movements of said avatar of said first participant based on said received movements of said second participant in response to said movements of said avatar of said first participant not exceeding said defined boundary of said virtual reality surrounding in said virtual environment.

14. The computer program product as recited in claim 13, wherein the program code further comprises the programming instructions for:
generating haptic feedback and/or visual feedback on a device worn by said first participant and/or said second participant corresponding to said movements of said avatar of said first participant.

15. The computer program product as recited in claim 12, wherein the program code further comprises the programming instructions for:
relinquishing control of said one or more limbs or said entirety of said avatar of said first participant by said second participant in response to said received movements of said second participant resulting in movements of said avatar of said first participant exceeding said defined boundary of said virtual reality surrounding in said virtual environment.

16. The computer program product as recited in claim 9, wherein the program code further comprises the programming instructions for:
relinquishing control of said one or more limbs or said entirety of said avatar of said first participant by said second participant in response to completion of said activity or said step of said activity performed by said avatar of said first participant in said virtual environment.

17. A system, comprising:
a memory for storing a computer program for controlling an avatar of a first participant by a second participant; and
a processor connected to the memory, wherein the processor is configured to execute program instructions of the computer program comprising:
receiving a selection of an activity or a step of said activity to be performed by said avatar of said first participant in a virtual environment that said first participant needs assistance in completing;
receiving a selection of one or more limbs of said avatar of said first participant or a selection of an entirety of said avatar of said first participant to be controlled by said second participant to complete said activity or said step of said activity; and
granting control of said one or more limbs or said entirety of said avatar of said first participant to said second participant.

18. The system as recited in claim 17, wherein the program instructions of the computer program further comprise:
accessing one or more sensors configured to monitor movements of said second participant to control said one or more limbs or said entirety of said avatar of said first participant.

19. The system as recited in claim 18, wherein the program instructions of the computer program further comprise:
receiving movements of said second participant from said one or more sensors to be reflected in movements of said avatar of said first participant.

20. The system as recited in claim 19, wherein the program instructions of the computer program further comprise:
receiving a defined boundary of a virtual reality surrounding in said virtual environment.
